(19) United States
(12) Patent Application Publication
(10) Pub. No.: US 2006/0037668 A1
(43) Pub. Date: Feb. 23, 2006

(54) Carving tool device

(76) Inventor: Chun Yuan Chang, Taichung (TW)

Correspondence Address: Chun Yuan CHANG, P.O. Box 63-99, Taichung, 406, TW

(21) Appl. No.: 10/923,166

(22) Filed: Aug. 23, 2004

(51) Int. Cl. B27C 1/00

(52) U.S. Cl. 144/154.5

(57) ABSTRACT

A carving tool device includes a supporting base having a bottom panel for engaging onto paper sheets or objects to be carved, and a carving tool attached onto the bottom panel and having a blade extendible through the bottom panel, for engaging onto the paper sheets, and for carving the paper sheets when the supporting base and the carving tool are moved relative to the paper sheets by the users. The supporting base includes a barrel attached to the bottom panel, and the carving tool includes a container adjustably attached to the barrel with such as a threaded engagement, for supporting the blade.

### BACKGROUND OF THE INVENTION

1. Field of the Invention

The present invention relates to a carving tool device, and more particularly to a carving tool device having a supporting base to facilitate operation of the carving tool device, and for easily carving paper sheets or the like.

2. Description of the Prior Art

Typical carving tool devices comprise a typical handle having a carving blade attached to one end of the handle, for being operated to cut or to carve paper sheets, woods, or other objects.

However, normally, the carving blades may not be uniformly applied or forced onto the paper sheets or other objects by the users, and may easily damage the paper sheets or other objects by the carving blades. In addition, the hands of the users may also be easily hurt or damaged by the carving blades.

The present invention has arisen to mitigate and/or obviate the afore-described disadvantages of the conventional carving tool devices.

### SUMMARY OF THE INVENTION

The primary objective of the present invention is to provide a carving tool device including a supporting base to facilitate operation of the carving tool device, and for easily carving paper sheets or the like, and for preventing users from being hurt or damaged by the carving tool device.

The other objective of the present invention is to provide a carving tool device including a spring biasing member for biasing the carving blade onto paper sheets or the like, and for allowing the paper sheets or the like to be uniformly cut or carved by the carving blade.

In accordance with one aspect of the invention, there is provided a carving tool device comprising a supporting base including a bottom panel for engaging onto objects to be carved, the bottom panel including at least one opening formed therein, and a carving tool attached onto the bottom panel of the supporting base, and including a blade extendible through the opening of the bottom panel, for engaging onto the objects, and for carving the objects when the supporting base and the carving tool are moved relative to the objects.

The supporting base includes a barrel attached to the bottom panel, and the carving tool includes a container attached to the barrel, for supporting the blade. The barrel includes an inner thread formed therein, the container includes an outer thread. formed thereon, for threading with the inner thread of the barrel, and for adjustably attaching the container to the barrel.

The container includes a bore formed therein, for slidably receiving the blade. The container includes a block slidably received in the bore thereof, and the blade is attached to the block. The container includes a spring member received in the bore thereof, for biasing the blade out of the container and out through the opening of the bottom panel.

The container includes a cap attached thereto, and engageable with the spring member, to retain the spring member in the bore of the container. The container includes a lid attached to the cap, for selectively shielding the blade. The cap includes a cavity formed therein to receive the lid and to attach the lid to the cap.

The supporting base includes a housing disposed on the bottom panel and having a chamber formed therein for receiving tool members. The supporting base includes at least one partition disposed in the chamber of the housing, and coupled between the housing and the barrel, to form at least one compartment in the housing.

The supporting base includes at least one cover attached thereon, to enclose the compartment of the housing. The supporting base includes a retainer disposed on the bottom panel, for retaining the container when the container is disengaged from the barrel.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a carving tool device in accordance with the present invention;

FIG. 2 is a perspective view of the carving tool device;

FIG. 3 is a partial cross sectional view of the carving tool device, taken along lines 3-3 of FIG. 2; and

FIG. 4 is a perspective view illustrating the operation of the carving tool device.

### DETAILED DESCRIPTION OF THE PREFERRED EMBODIMENT

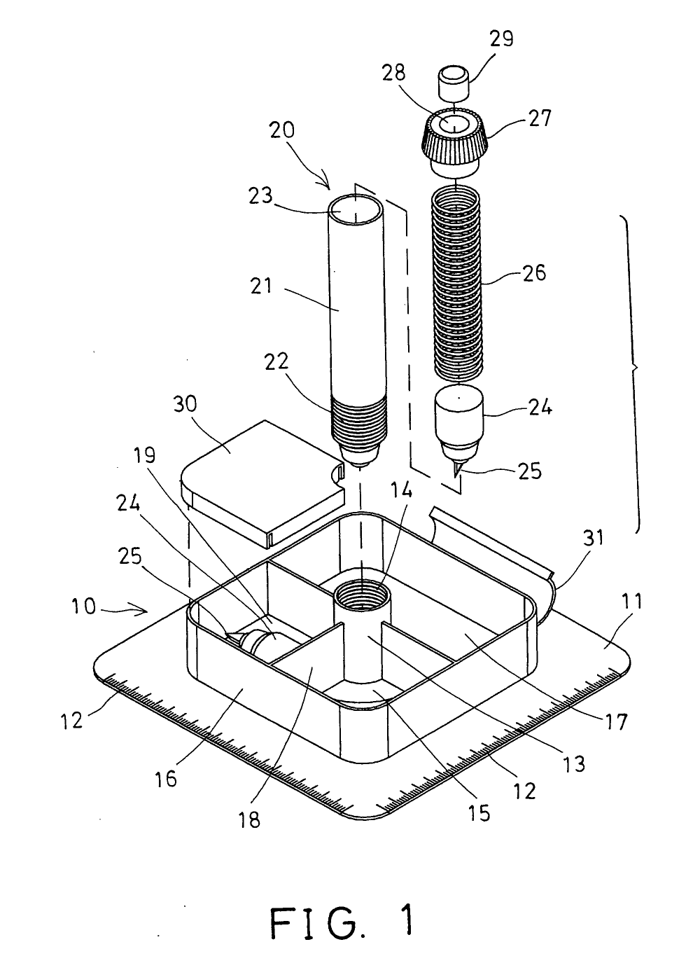

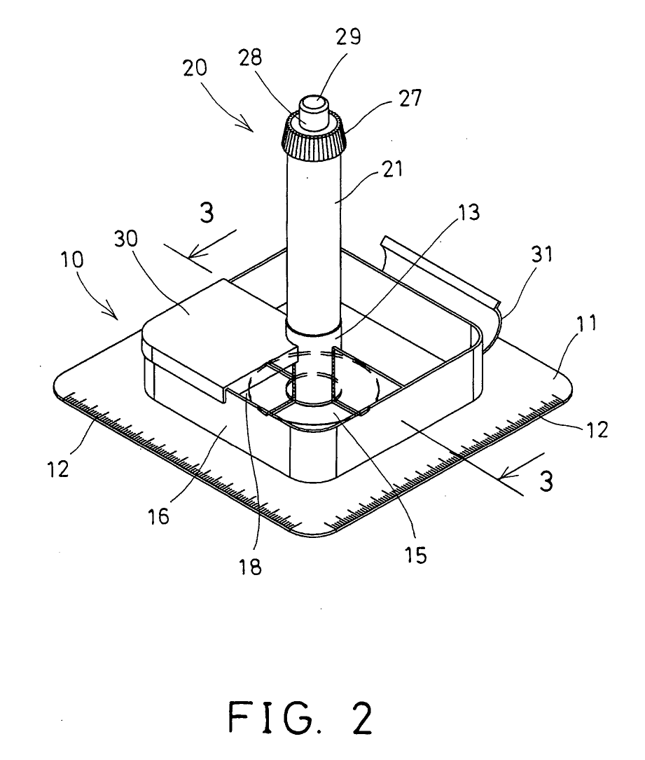

Referring to the drawings, and initially to FIGS. 1-3, a carving tool device in accordance with the present invention comprises a supporting base 10 including a bottom panel 11 having one or more graduations 12 formed or provided on outer peripheral portions thereof, and a barrel 13 attached to or extended upwardly from the bottom panel 11 and having an inner thread 14 formed or provided therein.

The bottom panel 11 includes one or more openings 15 formed therein, and preferably formed or located around and/or below the barrel 13, for allowing users to see through the bottom panel 11 and to see paper sheets or other objects onto which the bottom panel 11 of the supporting base 10 is engaged or attached thereto. The paper sheets or other objects are to be cut or carved or engraved with the carving tool device.

A carving tool 20 includes a tubular container 21 having an outer thread 22 formed or provided on the lower portion thereof, for threading with the inner thread 14 of the barrel 13, and for detachably attach the carving tool 20 to the barrel 13 of the supporting base 10, and for allowing the carving tool 20 to be threaded or adjusted relative to the barrel 13 to different heights or position.

The container 21 includes a bore 23 formed therein for slidably receiving a block 24 therein. A cutter or carving blade 25 is attached to the block 24, and movable and/or extendible downwardly or outwardly through the openings 15 of the bottom panel 11, for engaging onto the paper sheets or other objects to be cut or carved or engraved. A spring member 26 may also be received in the bore 23 of the container 21 and engaged with the block 24, for biasing the blade 25 out through the openings 15 of the bottom panel 11.

A cap 27 may be attached onto the upper portion of the container 21, and may be engaged with the spring member 26, for forcing the spring member 26 to bias against the block 24, and to force the blade 25 out through the openings 15 of the bottom panel 11. The cap 27 includes a cavity 28 formed therein for receiving or positioning a lid 29 thereto.

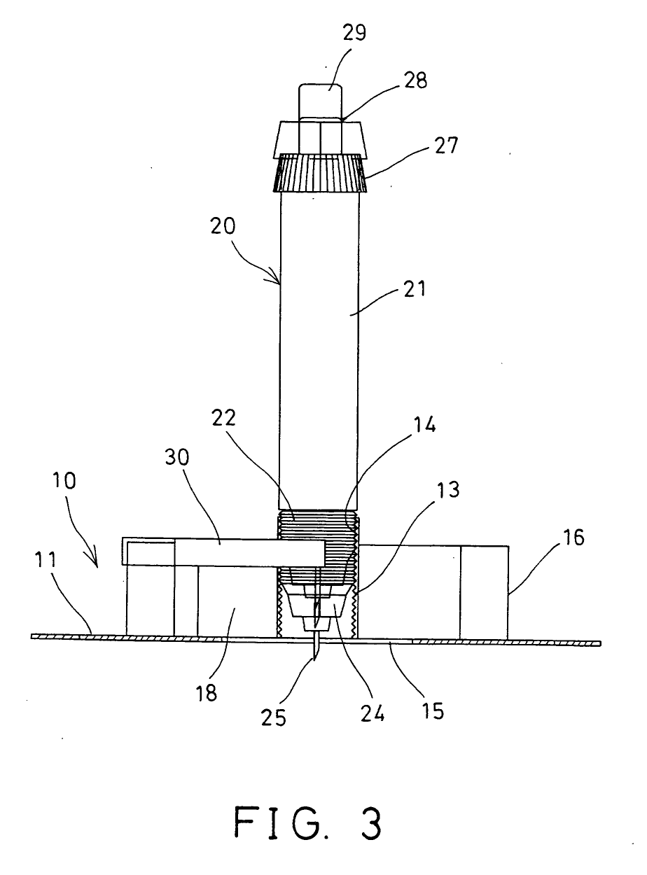

In operation, as shown in FIG. 3, the bottom panel 11 of the supporting base 10 may be engaged onto the paper sheets or other objects to be cut or carved or engraved, and the container 21 of the carving tool 20 may be threaded or adjusted relative to the barrel 13 to different heights or position, and thus to allow the blade 25 to be suitably moved out through the openings 15 of the bottom panel 11, and to suitably engaged onto the paper sheets or other objects.

It is to be noted that the spring biasing force of the spring member 26 applied onto the block 24 and the blade 25 may also be adjusted when the carving tool 20 and thus the blade 25 are adjusted relative to the barrel 13 to different heights or position and/or when the cap 27 is adjusted relative to the container 21, to allow the blade 25 to apply a suitable carving or engraving force against the paper sheets or other objects.

When the bottom panel 11 of the supporting base 10 are engaged onto the paper sheets or other objects to be cut or carved or engraved, the supporting base 10 and the carving tool 20 may be stably or smoothly moved relative to the paper sheets or other objects, to allow the paper sheets or other objects to be suitably cut or carved or engraved by the blade 25.

It is preferable that the supporting base 10 further includes a housing 16 attached to or extended upwardly from the bottom panel 11 and having a chamber 17 formed therein, and includes one or more partitions 18 extended or disposed in the chamber 17 of the housing 16, and coupled to the barrel 13, for supporting the barrel 13 on the bottom panel 11, and for forming or defining a number of compartments 19 therein.

One or more spare blocks 24 and/or blades 25 or other tool members (not shown) may be received in the compartments 19 of the housing 16, and one or more covers 30 may be attached onto the housing 16, to enclose the compartments 19 and/or the chamber 17 of the housing 16, and to stably retain the spare blocks 24 and/or the blades 25 or other tool members within the compartments 19 and/or the chamber 17 of the housing 16.

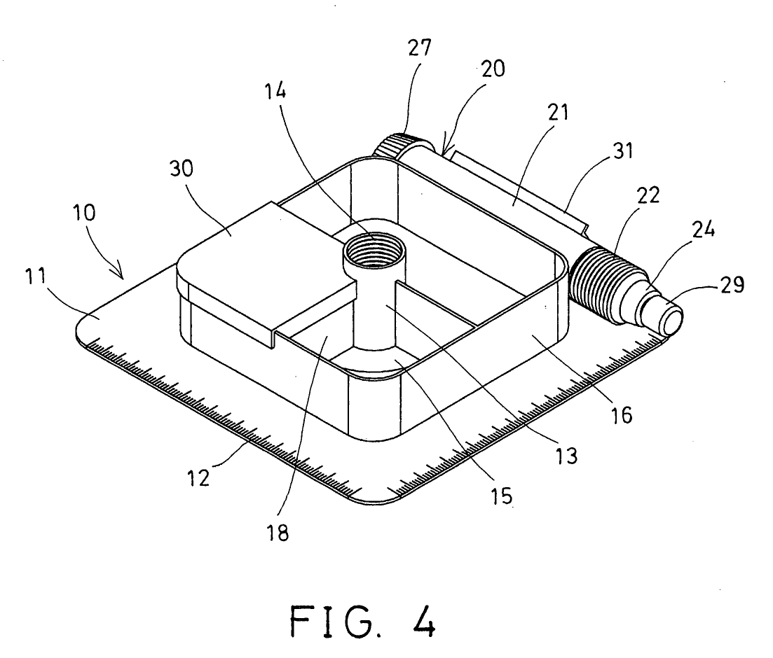

One or more clips or retainers 31 may further be provided and attached onto the bottom panel 11 of the supporting base 10, for clamping or retaining the container 21 of the carving tool 20 to the supporting base 10 (FIG. 4), when the container 21 of the carving tool 20 is disengaged from the barrel 13 of the supporting base 10. The lid 28 may be attached or engaged onto the block 24, to shield the blade 25, and to prevent the blade 25 from hurting the users or other people.

Accordingly, the carving tool device in accordance with the present invention includes a supporting base to facilitate operation of the carving tool device, and for easily carving paper sheets or the like, and for preventing users from being hurt or damaged by the carving tool device, and includes a spring biasing member for biasing the carving blade onto paper sheets or the like, and for allowing the paper sheets or the like to be uniformly cut or carved by the carving blade.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A carving tool device comprising:
a supporting base including a bottom panel for engaging onto objects to be carved, said bottom panel including at least one opening formed therein, and
a carving tool attached onto said bottom panel of said supporting base, and including a blade extendible through said at least one opening of said bottom panel, for engaging onto the objects, and for carving the objects when said supporting base and said carving tool are moved relative to the objects.

2. The carving tool device as claimed in claim 1, wherein said supporting base includes a barrel attached to said bottom panel, and said carving tool includes a container attached to said barrel, for supporting said blade.

3. The carving tool device as claimed in claim 2, wherein said barrel includes an inner thread formed therein, said container includes an outer thread formed thereon, for threading with said inner thread of said barrel, and for adjustably attaching said container to said barrel.

4. The carving tool device as claimed in claim 2, wherein said container includes a bore formed therein, for slidably receiving said blade.

5. The carving tool device as claimed in claim 4, wherein said container includes a block slidably received in said bore thereof, and said blade is attached to said block.

6. The carving tool device as claimed in claim 2, wherein said container includes a spring member received in said bore thereof, for biasing said blade out of said container and out through said at least one opening of said bottom panel.

7. The carving tool device as claimed in claim 6, wherein said container includes a cap attached thereto, and engageable with said spring member, to retain said spring member in said bore of said container.

8. The carving tool device as claimed in claim 7, wherein said container includes a lid attached to said cap, for selectively shielding said blade.

9. The carving tool device as claimed in claim 8, wherein said cap includes a cavity formed therein to receive said lid and to attach said lid to said cap.

10. The carving tool device as claimed in claim 2, wherein said supporting base includes a housing disposed on said bottom panel and having a chamber formed therein for receiving tool members.

11. The carving tool device as claimed in claim 10, wherein said supporting base includes at least one partition disposed in said chamber of said housing, and coupled between said housing and said barrel, to form at least one compartment in said housing.

12. The carving tool device as claimed in claim 11, wherein said supporting base includes at least one cover attached thereon, to enclose said at least one compartment of said housing.

13. The carving tool device as claimed in claim 2, wherein said supporting base includes a retainer disposed on said bottom panel, for retaining said container when said container is disengaged from said barrel.
